(19) United States
(12) Patent Application Publication
(10) Pub. No.: US 2013/0127731 A1
(43) Pub. Date: May 23, 2013

(54) REMOTE CONTROLLER, AND SYSTEM AND METHOD USING THE SAME

(71) Applicants: Byung-youn Song, Suwon-si (KR); Nag-eui Choi, Suwon-si (KR)

(72) Inventors: Byung-youn Song, Suwon-si (KR); Nag-eui Choi, Suwon-si (KR)

(21) Appl. No.: 13/670,619

(22) Filed: Nov. 7, 2012

(30) Foreign Application Priority Data
Nov. 17, 2011 (KR) 10-2011-0120339

(51) Int. Cl. G06F 3/01; G06F 3/02; G06F 3/041

(52) U.S. Cl. CPC G06F 3/017; G06F 3/041; G06F 3/0219
USPC 345/169; 345/156; 345/173

(57) ABSTRACT

Provided is a remote controller that enables a user of the remote controller to zoom in and zoom out on a selected object while holding the remote controller with one hand. Also provided is a system including the remote controller and a multimedia device including a display for displaying the object.

### CROSS-REFERENCE TO RELATED APPLICATION(S)

This application claims the benefit under 35 USC §119(a) of Korean Patent Application No. 10-2011-0120339, filed on Nov. 17, 2011, in the Korean Intellectual Property Office, the entire disclosure of which is incorporated herein by reference for all purposes.

### BACKGROUND

1. Field

The following description relates to a remote controller and a control system and method using the same, and more particularly, to a remote controller in which a user's usage is reflected.

2. Description of Related Art

Remote controllers are used to remotely control electronic devices, such as televisions, radios, audio systems, and the like. General remote controllers have various types of functional keys (for example, channel numbers, volume keys, power keys, etc.) to control electronic devices.

Recently, smart functions, such as the Internet, games, and social networking services (SNSs), have been included in electronic devices, such as Blu-ray players, multimedia players, and set-top boxes. As a result, remote controllers for controlling such electronic devices need to receive additional inputs. To address this, some remote controllers have added more key buttons, loaded the key buttons with more functions, or used complicated menu systems to receive various inputs. However, user interfaces for such conventional remote controllers typically require a large number of key buttons with a limited amount of space or depend on complicated sequences of key inputs and menu systems.

### SUMMARY

In an aspect, there is provided a remote controller for controlling an electronic device that includes a display, the remote controller including an input unit comprising a direction input unit to receive a direction manipulation of a user with respect to an object on the display, and a zoom input unit to receive a zoom manipulation from the user, a control command generation unit to generate a control command corresponding to the direction manipulation of the user and a zoom-out command or a zoom-in command according to the zoom manipulation of the user, and a controller side communication unit to transmit the control command to the electronic device.

The direction input unit may comprise a motion sensor, and the direction manipulation of the user may be performed according to a movement of the remote controller.

The control command generation unit may generate the control command to move an indicator displayed on the display of the electronic device in correspondence with the movement of the remote controller detected by the motion sensor.

The input unit may further comprise a confirmation button that receives a pressing manipulation of the user, and the control command generation unit may generate a command used to activate or execute the object displayed on the display unit of the electronic device in response to the pressing manipulation of the user input into the confirmation button.

The confirmation button may be disposed at the front top or the front middle top of the remote controller.

The zoom input unit may be disposed adjacent to the bottom of the confirmation button.

The zoom input unit may comprise a rectangular or fan shaped touch pad.

The zoom input unit may comprise a plurality of rectilinear or arc shaped touch sensors.

The plurality of rectilinear or arc shaped touch sensors may be spaced apart from each other by an equal gap or different gaps.

The zoom input unit may comprise direction keys disposed around the confirmation button.

The direction keys may perform a function of the direction input unit.

The zoom input unit may detect a direction of a user's touch, the control command generation unit may generate the zoom-out command in response to the user's detected touch being an upward direction, and generate the zoom-in command in response to the user's detected touch being in a downward direction.

A direction of the zoom-out command and the zoom-in command generated may be switched through a change in an initial setting.

The zoom input unit may detect a speed of the user's touch or a range thereof, and the control command generation unit may generate the zoom-out command or the zoom-in command having a zoom size corresponding to the speed of the user's touch or the range thereof detected by the zoom input unit.

In an aspect, there is provided a control system including an electronic device comprising a display unit for displaying an object that is zoomed out or zoomed in by manipulating a remote controller, and the remote controller comprising an input unit comprising a direction input unit to receive a direction manipulation of a user with respect to an object on the display, and a zoom input unit to receive a zoom manipulation from the user, a control command generation unit to generate a control command corresponding to the direction manipulation of the user and a zoom-out command or a zoom-in command according to the zoom manipulation of the user, and a controller side communication unit to transmit the control command to the electronic device.

In an aspect, there is provided a method of controlling an electronic device using a remote controller, the method including displaying one or more objects on a display unit of the electronic device, selecting an object by manipulating the remote controller with a single hand, and generating a control command used to zoom in or out on the selected object by receiving a zoom manipulation of a user with the single hand.

The zoom manipulation of the user may comprise touching a zoom input unit disposed at the front of the remote controller while the user moves his or her thumb while holding the remote controller with one hand.

A zoom-out command may be generated in response to the user's detected touch being in an upward direction, and a zoom-in command may be generated in response to the user's detected touch being in a downward direction.

A direction of the zoom-out command and the zoom-in command may be switched through a change in an initial setting.

The method may further comprise detecting a speed of the user's touch or a range thereof, and generating the zoom-out command or the zoom-in command comprising a zoom size corresponding to the speed of the user's touch or the range thereof.

Other features and aspects may be apparent from the following detailed description, the drawings, and the claims.

### BRIEF DESCRIPTION OF THE DRAWINGS

FIG. 1 is a diagram illustrating an example of a control system.

FIG. 2 is a block diagram illustrating an example of the control system of FIG. 1.

FIG. 3 is a diagram illustrating an example of a remote controller used in the control system of FIG. 1.

FIG. 4 is a diagram illustrating an example of confirmation manipulation of the remote controller.

FIG. 5 is a diagram illustrating an example of zoom-in and zoom-out manipulations of the remote controller.

FIG. 6 is a diagram illustrating an example of a manipulation by a user's right hand in the zoom-in and zoom-out manipulations.

FIG. 7 is a diagram illustrating an example of a manipulation by a user's left hand in the zoom-in and zoom-out manipulations of the remote controller.

FIG. 8 is a diagram illustrating an example of a control method.

FIG. 9 is a diagram illustrating another example of a control method.

FIG. 10 is a diagram illustrating another example of a control method.

FIG. 11 is a diagram illustrating another example of a remote controller.

FIG. 12 is a diagram illustrating another example of a remote controller.

FIG. 13 is a diagram illustrating another example of a remote controller.

FIG. 14 is a diagram illustrating another example of a remote controller.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

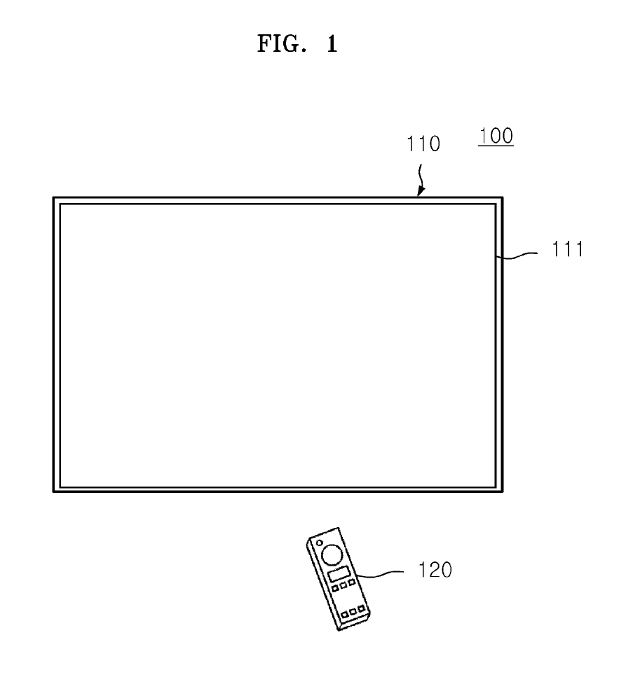

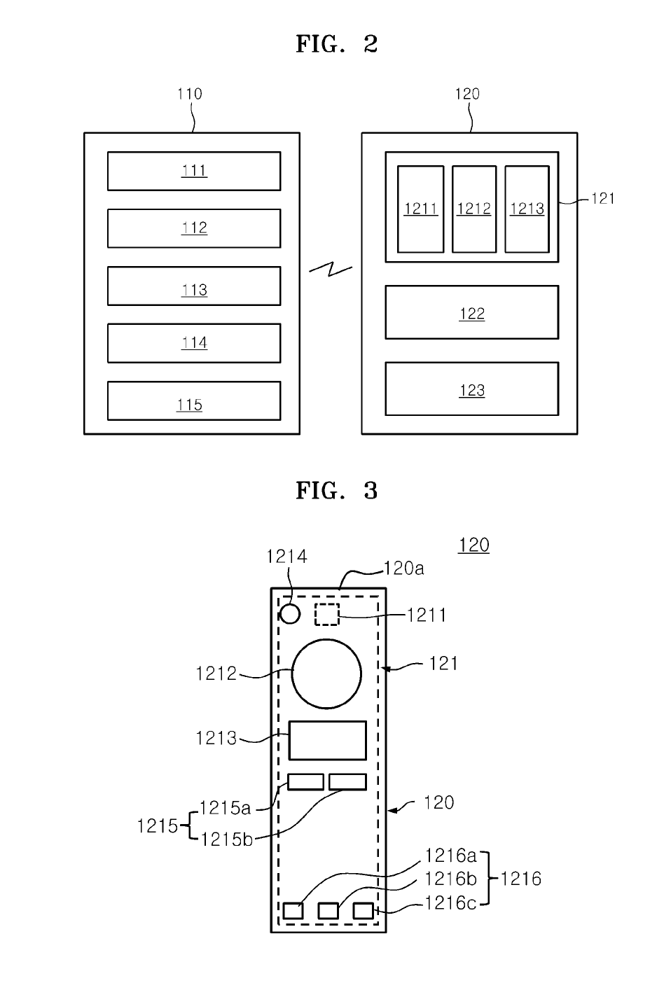

FIG. 1 illustrates an example of a control system 100. FIG. 2 illustrates a block diagram of the control system 100 of FIG. 1. FIG. 3 illustrates an example of a remote controller 120 used in the control system 100 of FIG. 1. Referring to FIGS. 1 through 3, the control system 100 includes an electronic device 110 and the remote controller 120.

For example, the electronic device 110 may include a display unit 111, a data input unit 112 that receives data from an outside source, a signal processing unit 113 that processes the received data, a host communication unit 114 that communicates with the remote controller 120, and a control unit 115. As an example, the electronic device 110 may be a smart television. As another example, the electronic device 110 may be a multimedia apparatus in which the display unit 111 is separated from or included in a device, such as a Blu-ray player, a multimedia player, a set-top box, a personal computer (PC), a game console, and the like.

The display unit 111 may include an image panel such as a liquid crystal panel, an organic light emitting panel, and the like. The display unit 111 may display contents and a graphic user interface (GUI). For example, the electronic device 110 may be a set-top box and the display unit 111 may be an external television connected to the set-top box.

The data input unit 112 may be an interface for receiving data such as contents displayed on the display unit 111. For example, the data input unit may include at least one of a Universal Serial Bus (USB), a Parallel Advanced Technology Attachment (PATA) or a Serial Advanced Technology Attachment (SATA), Flash Media, Ethernet, Wi-Fi, BLUETOOTH®, and the like. In some cases, the electronic device 110 may include an information storage apparatus (not shown) such as an optical disk drive to read data that is recorded on an optical disk.

The signal processing unit 113 may provide a user interface based on an operating system of the electronic device 110 and may decode the data received through the data input unit 112. For example, the signal processing unit 113 may provide a GUI that displays the contents such as a photo, video, a map, text or various application icons on the display unit 111. In this example, the signal processing unit 113 enables the displayed contents or application icons to be reproduced and/or executed.

The host communication unit 114 may receive a control command from the remote controller 120. For example, the host communication unit 114 may use a communication module such as an infrared communication module, a radio wave communication module, an optical communication module, and the like. For example, the infrared communication module may satisfy an infrared data association (IrDA) protocol. As another example, a communication module using a 2.4 GHz frequency or a communication module using Bluetooth may be used as the host communication unit 114.

The control unit 115 may control the respective elements of the electronic device 110, i.e., the display unit 111, the data input unit 112, the signal processing unit 113, and the host communication unit 114, based on a control command received through the host communication unit 114.

The remote controller 120 may include an input unit 121, a control signal generation unit 122, and a controller side communication unit 123. An exterior shape of the remote controller 120 is not limited to the size and shape shown in FIG. 3. For example, the exterior shape of the remote controller 120 may be a simple bar shape as shown in FIG. 1 or a linear shape.

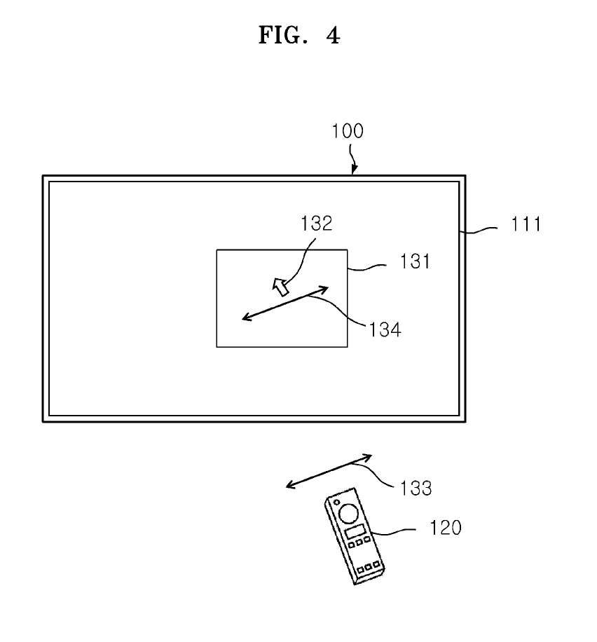

The input unit 121 may include a direction input unit 1211, a confirmation button 1212, and a zoom input unit 1213. For example, the direction input unit 1211 may be a motion sensor that senses a movement of the remote controller 120 such as a 2-axial or 3-axial inertial sensor. The motion sensor of the direction input unit 1211 may be included in the remote controller 120. The direction input unit 1211 may receive a user's direction manipulation indicating an object (131 of FIG. 4) displayed on the display unit 111 of the electronic device 110.

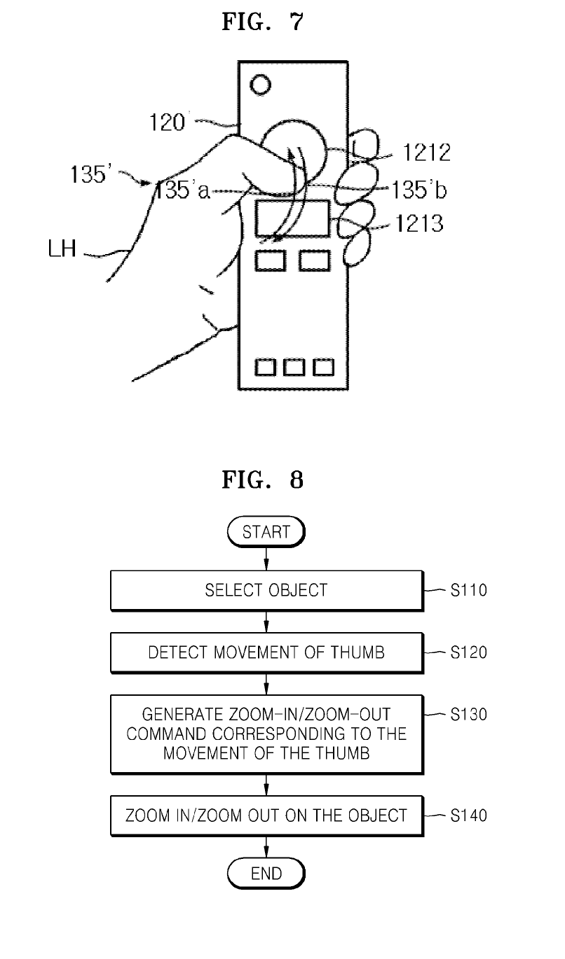

The confirmation button 1212 may receive the user's confirmation manipulation. For example, the confirmation button 1212 may be pressed by the user to generate a control signal used to confirm the object 131 displayed on the display unit 111 of the electronic device 110. The confirmation button 1212 may be a mechanical key button or a touch sensor. If a user holds the remote controller 120 with one hand, the confirmation button 1212 may be disposed at a point of the remote controller 120 where the user's thumb typically lies (see FIG. 6 or 7). For example, the confirmation button 1212 may be disposed at the front top or the front middle top of the remote controller 120. In this example, when the user holds the remote controller 120 with one hand, an edge of the user's thumb naturally lies on the confirmation button 1212.

The zoom input unit 1213 may receive a user's zooming manipulation to generate a control signal used to zoom in or out on the object displayed on the display unit 111 of the electronic device 110. For example, the zoom input unit 1213 may be a rectangular shaped touch pad disposed in the bottom of the confirmation button 1212 as shown in FIG. 3. The touch pad may include, for example, a two-layer conducting wire that extends horizontally at one layer and vertically at another layer to overlap in a grid form, and have a matrix structure in which a semiconductor is filled between the two layers. For example, a single touch pad or a multi-touch pad may be used as the zoom input unit 1213 of the present example. The zoom input unit 1213 of the touch pad type may sense the touch of a user's finger as well as detect whether the user's finger moves downward or upward.

The zoom input unit 1213 may detect a movement range (i.e., a region of the zoom input unit 1213 touched by the user's finger) of the user's finger. For example, the zoom input unit 1213 may have spatial resolution or temporal resolution with respect to the touch sense of the user's finger.

The input unit 121 may further include keys frequently used by the user. For example, a power key 1214 that powers the electronic device 110 on and off may be disposed at a corner of the front top of the remote controller 120. The input unit 121 may further include a function key 1215 including a home button 1215a that allows the electronic device 110 to return to a main user interface and/or a back button 1215b that allows the electronic device 110 to return to a previous user interface. The function key 1215 may be disposed at the bottom of the zoom input unit 1213 in consideration of the movement of the user's finger.

As an example, if the electronic device 110 is a Blu-ray player or a multimedia player, the input unit 121 may further include a player dedicated key 1216 including a reward button 1216a, a play button 1216b, and a forward button 1216c. The player dedicated key 1216 may be disposed, for example, at the front bottom of the remote controller 120. The power key 1214, the function key 1215, and the player dedicated key 1216 are merely exemplary and the examples herein are not limited thereto.

The control signal generation unit 122 may generate control commands corresponding to signals generated from the input unit 121. The controller side communication unit 123 may transmit the control commands generated by the control signal generation unit 122 to the electronic device 110. The controller side communication unit 123 corresponds to the host communication unit 114 and may use a communication module such as the infrared communication module, the radio wave communication module, the optical communication module, and the like, to correspond to the host communication unit 114.

FIG. 4 illustrates an example of confirmation manipulation of the remote controller 120.

Referring to FIG. 4, the object 131 is displayed on the display unit 111 of the electronic device 110. For example, the object 131 may be contents such as a photo, video, a map, or text or an application icon constituting a GUI. Also, an indicator 132 that moves according to a user's manipulation of a direction is displayed on the display unit 111. As described herein, because the direction input unit 1211 is included in the remote controller 120, a movement 133 of the remote controller 120 may be detected. The control command generation unit 122 may generate a control command corresponding to the movement 133 of the remote controller 120. The controller side communication unit 123 may transfer the generated control command to the electronic device 110. The control unit 115 of the electronic device 110 may implement a movement 134 of the indicator 132 displayed on the display unit 111 based on the transferred control command. For example, a user may indicate the object 131 to be selected by moving (generating the movement 133) the remote controller 120 and accordingly moving the indicator 132, thereby controlling the electronic device 110 by matching user's senses of sight and touch with each other.

The user may confirm the object 131 indicated by the indicator 132 by pressing the confirmation button 1212 of the remote controller 120 with their thumb. In this example, a confirmation may be an activation of the object 131 or an execution thereof. The activation of the object 131 is a state in which the object 131 is ready to be executed. For example, the activation state of the object 131 may be represented by inverting a color of the object 131 or slightly magnifying the object 131. The execution of the object 131 may correspond to contents being played, a corresponding application being executed, and the like.

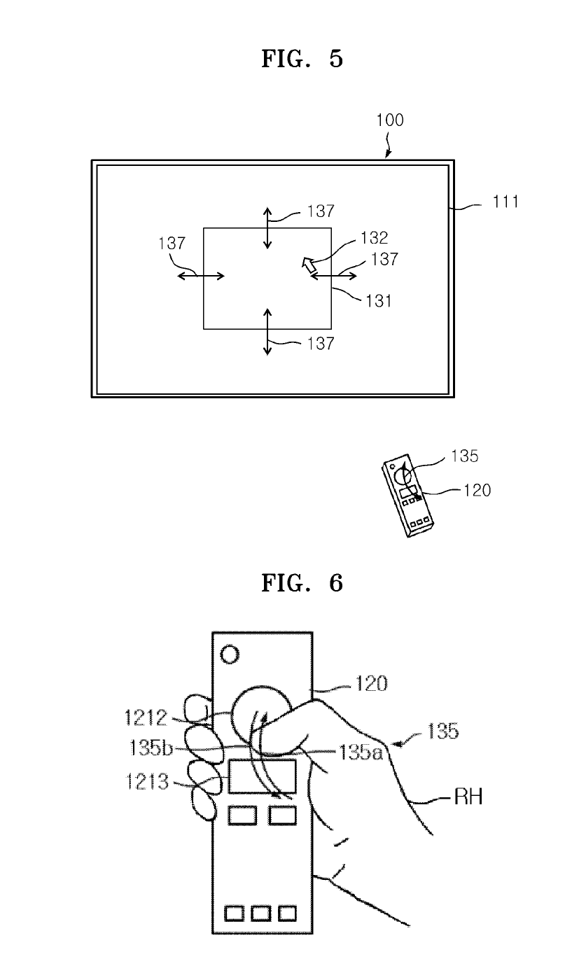

The manipulation of the remote controller 120 described with reference to FIG. 4 merely ends up selecting the object 131, and it is somewhat difficult to input a command to zoom in or out on the selected object 131. According to various aspects, the control system 100 may enable the manipulation of the remote controller 120 to zoom in or out on the selected object 131 as is described in the examples with reference to FIGS. 5 through 11.

FIG. 5 illustrates an example of a manipulation of the remote controller 120. FIG. 6 illustrates an example of a movement of a user's finger in the manipulation of the remote controller 120.

Referring to FIGS. 5 and 6, a user may manipulate the remote controller 120 to zoom in or out 137 on the corresponding object 131 by holding the remote controller 120 with his or her right hand RH without using his or her left hand. For example, the user may manipulate the remote controller 120 to zoom out on the corresponding object 131 by pushing his or her thumb upward 135a while holding the remote controller 120 with his or her right hand RH. Also, the user may manipulate the remote controller 120 to zoom in on the corresponding object 131 by pulling his or her thumb downward 135b while holding the remote controller 120 with his or her right hand RH.

If the user pushes the thumb upward 135a or pulls the thumb downward 135b, it may be natural that a user touches the input unit 1213 along an arc shaped curve. The control command generation unit 122 may determine a direction of a movement of the thumb detected by the zoom input unit 1213 as well as a trace (hereinafter referred to as a touch trace) formed by the touch part of the thumb. The control command generation unit 122 may determine whether a signal input into the zoom input unit 1213 is a zoom-in signal or a zoom-out signal based on the determined curve. For example, if the touch trace detected by the zoom input unit 1213 is smaller than the predetermined curvature, the control command generation unit 122 may determine that the signal input into the zoom input unit 1213 is an abnormal input and may not generate the zoom-in signal or the zoom-out signal. As another example, if the touch trace detected by the zoom input unit 1213 is greater than the predetermined curvature, the control command generation unit 122 may determine the signal input into the zoom input unit 1213 as the abnormal input and may not generate the zoom-in signal or the zoom-out signal.

FIG. 7 illustrates an example in which a user manipulates the remote controller 120 to zoom in or out on the corresponding object 131 only according to a movement 135′ of the thumb of his or her left hand LH without using his or her right hand RH. In this example, the user may zoom out on the corresponding object 131 by pushing the thumb of his or her left hand LH upward 135′a or may zoom in the corresponding object 131 by pulling the thumb of his or her left hand LH downward 135′b.

In a conventional user interface, the user inconveniently needs to select multi-step menus in order to zoom-out or zoom-in on the corresponding object 131 using a remote controller. In another conventional user interface, the user manipulates the remote controller to zoom out on the corresponding object 131 by touching two fingers on a touch screen and unfolding the two fingers or to zoom in on the corresponding object 131 by inversely folding the two fingers, which makes it very difficult to manipulate the remote controller with one hand. In another example of a conventional user interface, the user manipulates the remote controller to zoom in or out on the corresponding object 131 using a scroll button that is different from a GUI provided to a smart phone, etc., which inconveniences the user who wants to operate in the same user environment.

The remote controller 120 according to various aspects may be used to intuitively zoom in or out on the object 131 through the zoom input unit 1213, and use the GUI provided to the smart phone, etc., thereby providing the user who wants the same user environment with increased convenience.

FIG. 8 illustrates an example of a control method.

Referring to FIG. 8, the electronic device 110 displays the object 131 on the display unit 111. A user moves the indicator 132 displayed on the display unit 111 by moving the remote controller 120. The corresponding object 131 is selected (S110) by placing the indicator 132 on the object 131 on which zoom in or zoom out is to be performed. For example, the user may activate the object 131 indicated by the indicator 132 by pressing the confirmation button 1212 of the remote controller 120.

Next, the user passes the zoom input unit 1213 while touching his or her thumb on the zoom input unit 1213. In this example, the zoom input unit 1213 detects a movement (i.e. a touch and moving direction) of the thumb, and transmits a signal corresponding to the movement of the thumb to the control command generation unit 122 (S120).

The control command generation unit 122 determines whether the thumb moves in a direction such as upward or downward, and generates a zoom-out command or a zoom-in command according to a direction of the movement of the thumb (S130). The zoom-out command or the zoom-in command generated according to the direction of the movement of the thumb may be determined based on a previously determined setting. For example, if the control command generation unit 122 determines that the thumb moves upward, the control command generation unit 122 may generate the zoom-out command used to zoom out on the object 131 indicated by the indicator 132, and, if the control command generation unit 122 determines that the thumb moves downward, the control command generation unit 122 may generate the zoom-in command used to zoom in on the object 131 indicated by the indicator 132. The zoom-out command or the zoom-in command may be switched by changing the setting according to a user's selection.

The zoom-out command or the zoom-in command generated by the control command generation unit 122 is transferred to the electronic device 110 to zoom out or in on the object 131 indicated by the indicator 132 on the display unit 111 (S140). For example, a zoom-out level or a zoom-in level of the object 131 may be determined based on a number of times the thumb passes the zoom input unit 1213. For example, if the thumb passes the zoom input unit 1213 one time, the object 131 may be zoomed out or in at a previously set size one time. As another example, if the thumb passes the zoom input unit 1213 a plurality of times, the object 131 may be zoomed out or in at a set size that plurality of times.

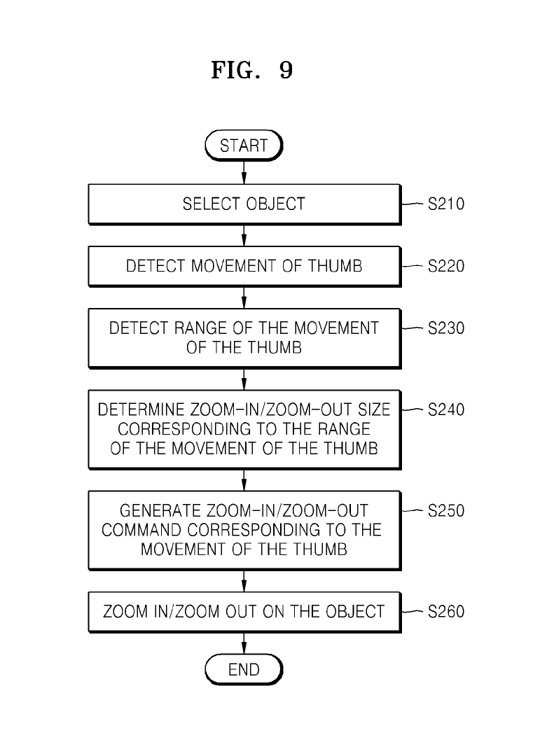

FIG. 9 illustrates another example of a control method.

Referring to FIG. 9, a user selects the object 131 by moving the remote controller 120 (S210). The zoom input unit 1213 detects a movement of the thumb (S220) and detects a range of the movement of the thumb (S230). For example, the zoom input unit 1213 may simultaneously detect the movement and the range of movement of the thumb. The control command generation unit 122 determines a zoom-out size of the object 131 or a zoom-in size thereof corresponding to the detected range of the movement of the thumb (S240). For example, the zoom-out size of the object 131 or the zoom-in size thereof in relation to the detected range of the movement of the thumb may be previously set and stored in a memory (not shown) as a lookup table.

The control command generation unit 122 generates a zoom-out command or a zoom-in command corresponding to a direction of the movement of the thumb detected by the zoom input unit 1213 (S250). The zoom-out command or the zoom-in command generated by the control command generation unit 122 is transferred to the electronic device 110 so that the electronic device 110 zooms out or zooms in on the object 131 displayed on the display unit 111 at a corresponding size selected by the user and detected by the zoom input unit 1213 (S260). For example, the object 131 may be zoomed out or zoomed in to interact with a user's touch in real time, and thus, when the user touches the zoom input unit 1213 with his or her thumb, a range of the thumb's touch may be intuitively determined.

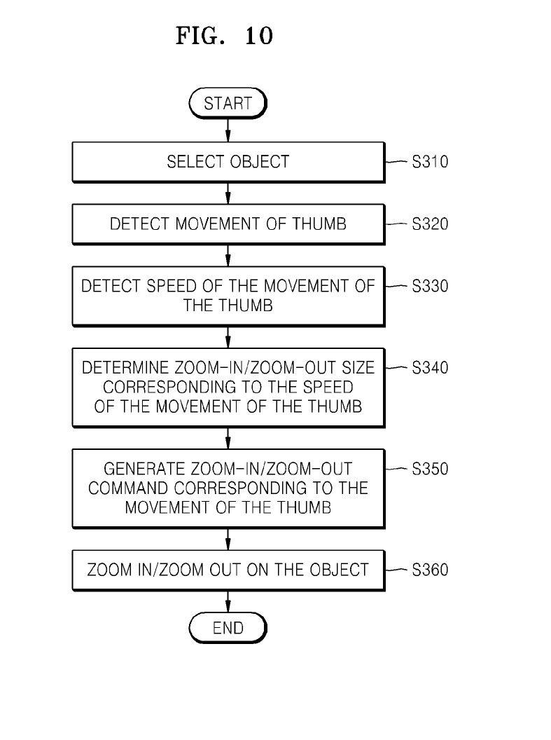

FIG. 10 illustrates another example of a control method.

Referring to FIG. 10, a user selects the object 131 by moving the remote controller 120 (S310). The zoom input unit 1213 detects a movement of the thumb (S320) and simultaneously detects a speed of the movement of the thumb (S330). The control command generation unit 122 determines a zoom-out size of the object 131 or a zoom-in size thereof corresponding to the detected speed of the movement of the thumb (S340).

For example, if the detected speed of the movement of the thumb is fast, the control command generation unit 122 may determine that the zoom-out size of the object 131 or the zoom-in size thereof is larger. As another example, if the detected speed of the movement of the thumb is slow, the control command generation unit 122 may determine that the zoom-out size of the object 131 or the zoom-in size thereof is smaller. For example, the zoom-out size of the object 131 or the zoom-in size thereof in relation to the detected speed of the movement of the thumb may be previously set and stored in a memory (not shown) as a lookup table.

In addition, the control command generation unit 122 generates a zoom-out command or a zoom-in command corresponding to a direction of the movement of the thumb detected by the zoom input unit 1213 (S350). The zoom-out command or the zoom-in command generated by the control command generation unit 122 is transferred to the electronic device 110 and the electronic device 110 zooms out or zooms in on the object 131 displayed on the display unit 111 at a size selected by the user and detected by the zoom input unit 1213 (S360). The object 131 may be zoomed out or zoomed in to interact with a user's touch in real time, and thus, when the user touches the zoom input unit 1213 with his or her thumb, a speed of the movement of the thumb may be intuitively determined.

Although the example of the zoom input unit 122 of the remote controller 120 is described as a rectangular shaped touch pad, the zoom input unit 122 is not limited thereto.

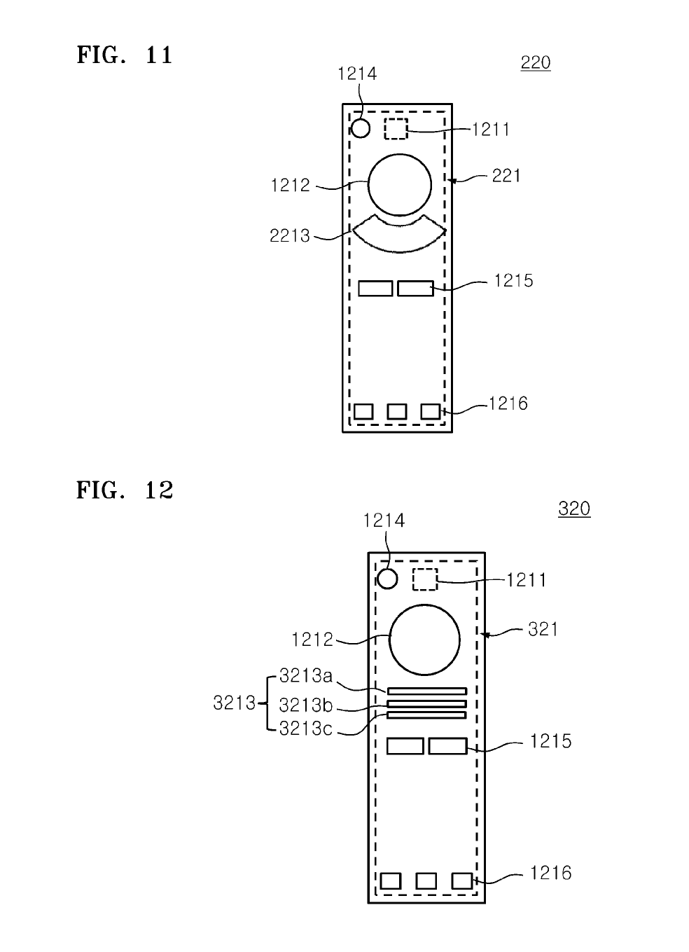

FIG. 11 illustrates another example of a remote controller 220 used in the control system 100.

Referring to FIG. 11, the remote controller 220 of the present example is substantially the same as the remote controller 120 of the above-described embodiment, except that a zoom input unit 2213 of an input unit 221 is a fan-shaped touch pad. In this example, if a user touches the zoom input unit 2213 with his or her thumb while holding the remote controller 220, an arc shape is drawn with respect to a joint of his or her thumb. Such a user's usage is reflected to form the zoom input unit 2213 in a fan shape.

FIG. 12 illustrates another example of a remote controller 320 used in the control system 100.

Referring to FIG. 12, the remote controller 320 is substantially the same as the remote controller 120 of the above-described embodiment, except that a zoom input unit 3213 of an input unit 321 includes three touch sensors 3213a, 3213b, and 3213c. The three touch sensors 3213a, 3213b, and 3213c have long and rectilinear shapes and are spaced in parallel to each other with predetermined gaps at a bottom portion of a confirmation button 3213. For example, the three touch sensors 3213a, 3213b, and 3213c may be spaced apart from each other by equal gaps or by different gaps.

The shape of the zoom input unit 3213 may have a geometric arrangement structure that exhibits an esthetic characteristic. The three touch sensors 3213a, 3213b, and 3213c may use, for example, static type touch sensors, capacitance type touch sensors, and the like. As another example, a user's touch may be detected through an amount of impedance or a change thereof such as resistance, capacitance, and reactance detected by the touch sensors 3213a, 3213b, and 3213c, respectively.

Although the zoom input unit 3213 includes the three touch sensors 3213a, 3213b, and 3213c in the present example, the remote controller is not limited thereto, and the zoom input unit 3213 may include, one, two, or four or more touch sensors.

If the user moves his or her thumb on the zoom input unit 3213 while holding the remote controller 320 with one hand, the three touch sensors 3213a, 3213b, and 3213c may sequentially generate contact signals. In this example, a sequence of the contact signals of the three touch sensors 3213a, 3213b, and 3213c may be used to determine whether the thumb moves upward (see 135a of FIG. 6) or downward (see 135b of FIG. 6).

According to various aspects, a touch region may be detected based on which of the three touch sensors 3213a, 3213b, and 3213c generate the contact signals. As another example, the speed of the movement of the thumb may be detected through an interval of the contact signals generated by the touch sensors 3213a, 3213b, and 3213c. As described with reference to FIGS. 9 and 10, such a touch region or speed of movement of the thumb may be used to determine a zoom-in level or a zoom-out level.

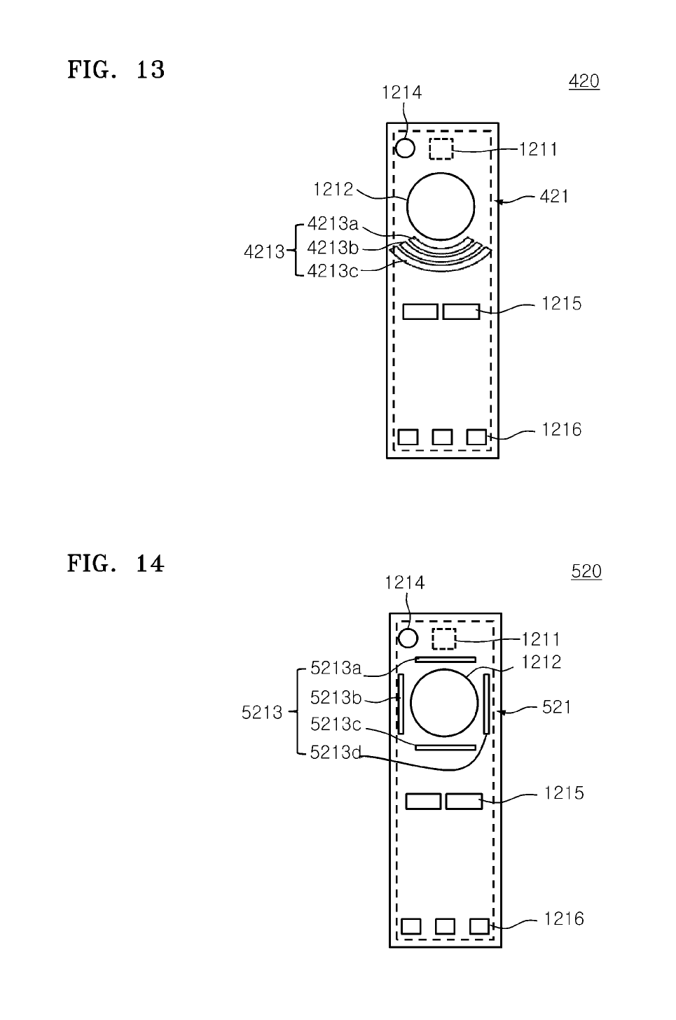

FIG. 13 illustrates another example of a remote controller 420 used in the control system 100.

Referring to FIG. 13, the remote controller 420 is substantially the same as the remote controller 120 of the above-described embodiment, except that a zoom input unit 4213 of an input unit 421 includes touch sensors 4213a, 4213b, and 4213c. The touch sensors 4213a, 4213b, and 4213c may have arc shapes and may be spaced apart from each other by an equal gap or by different gaps. The touch sensors 4213a, 4213b, and 4213c may use, for example, static type touch sensors, capacitance type touch sensors, and the like. The shape of the zoom input unit 4213 may have a geometric arrangement structure that exhibits an esthetic characteristic.

FIG. 14 illustrates another example of a remote controller 520 used in the control system 100.

Referring to FIG. 14, a zoom input unit 5213 of an input unit 521 of the remote controller 520 includes direction keys 5213a, 5213b, 5213c, and 5213d disposed around the confirmation button 1212. The direction keys 5213a, 5213b, 5213c, and 5213d may use, for example, touch sensors such as static type touch sensors, capacitance type touch sensors, and the like.

For example, if a user moves his or her thumb from down to up with respect to the confirmation button 1212 while holding the remote controller 520 with one hand, the thumb may touch the lower direction key 5213c and then the upper direction key 5213a. Based on a movement of the right thumb when holding the remote controller 520 with the right hand, an upward movement of the right thumb may indicate that the right thumb touches the lower direction key 5213c and then the upper direction key 5213d. As another example, a downward movement of the right thumb may indicate that, for example, the right thumb touches the upper direction key 5213a and then the lower direction key 5213c or the upper direction key 5213d and then the lower direction key 5213c. When holding with the left hand, a left thumb may have a bilaterally symmetrical movement.

The upward movement of the thumb may correspond to, for example, a zoom-out command in relation to the object 131 (of FIG. 4). As another example, the downward movement of the thumb may correspond to a zoom-in command in relation to the object 131. The zoom-out command and the zoom-in command may be switched according to an initial setting.

In this example, the zoom input unit 5123 includes the direction keys 5213a, 5213b, 5213c, and 5213d, and thus a movement of the indicator 132 displayed on the display unit 111 may be manipulated through the direction keys 5213a, 5213b, 5213c, and 5213d. Thus, the direction input unit 1211 may be omitted in the present embodiment.

According to various aspects, the remote controller, and the control system and method using the same may intuitively and easily control zoom-out and zoom-in that is performed on an object that is displayed on a screen.

Program instructions to perform a method described herein, or one or more operations thereof, may be recorded, stored, or fixed in one or more computer-readable storage media. The program instructions may be implemented by a computer. For example, the computer may cause a processor to execute the program instructions. The media may include, alone or in combination with the program instructions, data files, data structures, and the like. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The program instructions, that is, software, may be distributed over network coupled computer systems so that the software is stored and executed in a distributed fashion. For example, the software and data may be stored by one or more computer readable storage mediums. Also, functional programs, codes, and code segments for accomplishing the example embodiments disclosed herein can be easily construed by programmers skilled in the art to which the embodiments pertain based on and using the flow diagrams and block diagrams of the figures and their corresponding descriptions as provided herein. Also, the described unit to perform an operation or a method may be hardware, software, or some combination of hardware and software. For example, the unit may be a software package running on a computer or the computer on which that software is running.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A remote controller for controlling an electronic device that includes a display, the remote controller comprising:
an input unit comprising a direction input unit to receive a direction manipulation of a user with respect to an object on the display, and a zoom input unit to receive a zoom manipulation from the user;
a control command generation unit to generate a control command corresponding to the direction manipulation of the user and a zoom-out command or a zoom-in command according to the zoom manipulation of the user; and
a controller side communication unit to transmit the control command to the electronic device.

2. The remote controller of claim 1, wherein the direction input unit comprises a motion sensor, and the direction manipulation of the user is performed according to a movement of the remote controller.

3. The remote controller of claim 2, wherein the control command generation unit generates the control command to move an indicator displayed on the display of the electronic device in correspondence with the movement of the remote controller detected by the motion sensor.

4. The remote controller of claim 1, wherein the input unit further comprises a confirmation button that receives a pressing manipulation of the user, and the control command generation unit generates a command used to activate or execute the object displayed on the display unit of the electronic device in response to the pressing manipulation of the user input into the confirmation button.

5. The remote controller of claim 1, wherein the confirmation button is disposed at the front top or the front middle top of the remote controller.

6. The remote controller of claim 5, wherein the zoom input unit is disposed adjacent to the bottom of the confirmation button.

7. The remote controller of claim 1, wherein the zoom input unit comprises a rectangular or fan shaped touch pad.

8. The remote controller of claim 1, wherein the zoom input unit comprises a plurality of rectilinear or arc shaped touch sensors.

9. The remote controller of claim 8, where the plurality of rectilinear or arc shaped touch sensors are spaced apart from each other by an equal gap or different gaps.

10. The remote controller of claim 1, wherein the zoom input unit comprises direction keys disposed around the confirmation button.

11. The remote controller of claim 10, wherein the direction keys perform a function of the direction input unit.

12. The remote controller of claim 1, wherein the zoom input unit detects a direction of a user's touch, the control command generation unit generates the zoom-out command in response to the user's detected touch being an upward direction, and generates the zoom-in command in response to the user's detected touch being in a downward direction.

13. The remote controller of claim 12, wherein a direction of the zoom-out command and the zoom-in command generated are switched through a change in an initial setting.

14. The remote controller of claim 1, wherein the zoom input unit detects a speed of the user's touch or a range thereof, and the control command generation unit generates the zoom-out command or the zoom-in command having a zoom size corresponding to the speed of the user's touch or the range thereof detected by the zoom input unit.

15. A control system comprising:
an electronic device comprising a display unit for displaying an object that is zoomed out or zoomed in by manipulating a remote controller; and
the remote controller comprising:
an input unit comprising a direction input unit to receive a direction manipulation of a user with respect to an object on the display, and a zoom input unit to receive a zoom manipulation from the user;
a control command generation unit to generate a control command corresponding to the direction manipulation of the user and a zoom-out command or a zoom-in command according to the zoom manipulation of the user; and
a controller side communication unit to transmit the control command to the electronic device.

16. A method of controlling an electronic device using a remote controller, the method comprising:
displaying one or more objects on a display unit of the electronic device;
selecting an object by manipulating the remote controller with a single hand; and
generating a control command used to zoom in or out on the selected object by receiving a zoom manipulation of a user with the single hand.

17. The method of claim 16, wherein the zoom manipulation of the user comprises touching a zoom input unit disposed at the front of the remote controller while the user moves his or her thumb while holding the remote controller with one hand.

18. The method of claim 17, wherein a zoom-out command is generated in response to the user's detected touch being in an upward direction, and a zoom-in command is generated in response to the user's detected touch being in a downward direction.

19. The method of claim 18, wherein a direction of the zoom-out command and the zoom-in command are switched through a change in an initial setting.

20. The method of claim 17, further comprising:
detecting a speed of the user's touch or a range thereof; and
generating the zoom-out command or the zoom-in command comprising a zoom size corresponding to the speed of the user's touch or the range thereof.
